(19) United States
(12) Patent Application Publication
(10) Pub. No.: US 2002/0127347 A1
(43) Pub. Date: Sep. 12, 2002

(54) Method and apparatus for producing coated plate

(75) Inventors: Shinsuke Ochiai, Niihama-shi (JP); Kouichirou Watanabe, Niihama-shi (JP); Nissho Iwamoto, Yao-shi (JP); Masaji Kawasaki, Kashiba-shi (JP)

Correspondence Address: SUGHRUE MION, PLLC, 2100 PENNSYLVANIA AVENUE, N.W., WASHINGTON, DC, 20037, US

(73) Assignee: SUMITOMO CHEMICAL COMPANY, LIMITED, MEIHAN SHINKU KOGYO COMPANY LIMITED

(21) Appl. No.: 10/079,842

(22) Filed: Feb. 22, 2002

(30) Foreign Application Priority Data
Mar. 2, 2001 (JP) 2001-057926

(51) Int. Cl. B05D 1/28

(52) U.S. Cl. 427/428; 118/216; 118/224

(57) ABSTRACT

The present invention provides a method for producing a coated plate comprising the steps of: holding a plate in such a manner that surfaces of the plate to be coated is aligned substantially parallel to a gravity direction; placing the plate between two coating rolls having substantially horizontal rotation axes; passing the plate between the coating rolls, wherein a coating solution is supplied to at least one coating roll and the plate almost contacts with the coating rolls, by moving the plate upward and/or moving the coating rolls downward while causing the coating rolls to rotate in a direction opposite to movement of the plate; and forming a film of the coating solution on at least one surface of the plate. By this method, a coated plate having substantially even coating thickness is obtained and both sides of a plate can be coated at a time and at a faster speed, which results in a superior productivity.

### BACKGROUND OF THE INVENTION

1. Technical Field of the Invention

The present invention relates to a method for producing a coated plate with a coating solution containing colorants or ingredients which will afford various functional characteristics such as scratch resistance, antistatic property, antireflection, stain proof, defogging property and light absorbency, so that a coated film with various functional, protective, colored, and design capabilities is formed. A suitable coating apparatus for carrying out the above method is provided as well.

2. Description of the Related Art

As a method for coating chemical solutions to surfaces of a plate, various coating techniques have been conventionally employed, such as dip coating, flow coating, curtain flow coating or roll coating.

However, none of these known methods are fully satisfactory from the viewpoint of productivity or precision of a coated film thickness. For example, a dip coating method allows simultaneous coating to both surfaces of a plate and achieves a high precision of a coated film thickness, but has a disadvantage of very slow coating speed. A curtain flow coating or roll coating method can obtain substantially even coated film thickness at a fast coating speed, but is less productive since a rear side of a plate must be evenly supported, which makes it difficult to coat the both surfaces at a time. Some arrangement can be made for coating both surfaces at a time, but even in this case the production efficiency is not satisfactory since supporting parts are inevitably left uncoated. Further, a flow coating method allows simultaneous coating under a simple operation, but has a disadvantage of inferior precision of a coated film thickness.

### SUMMARY OF THE INVENTION

In view of the foregoing disadvantage incidental to the prior arts, present inventors studied to develop a productive method for producing a coated plate, that provides substantially even thickness of a coated film and allows quick and simultaneous coating to both surfaces of a plate, and an appropriate apparatus for carrying out the mentioned method. As a result, a highly productive method for producing a coated plate that affords desired coating has been established, wherein two coating rolls are placed in such a way that rotation axes thereof are substantially horizontal to the ground, and a plate which is aligned substantially vertical is passed between the coating rolls, wherein the plate almost contacts with the rolls.

That is, the present invention provides a method for producing a coated plate comprising the steps of: holding a plate in such a manner that surfaces of the plate to be coated is aligned substantially parallel to a gravity direction; placing the plate between two coating rolls having substantially horizontal rotation axes; passing the plate between the coating rolls, wherein a coating solution is supplied to at least one coating roll and the plate almost contacts with the coating rolls, by moving the plate upward and/or moving the coating rolls downward while causing the coating rolls to rotate in a direction opposite to movement of the plate; and forming a film of the coating solution on at least one surface of the plate.

In addition, the present invention provides an apparatus for producing a coated plate comprising: a means of holding the plate in such a manner that surfaces of the plate to be coated is aligned substantially parallel to a gravity direction; two coating rolls having substantially horizontal rotation axes and confronting each other with a clearance therebetween that allows the plate to pass through and almost contact with, and which rotate in a direction opposite to each other and to movement of the plate; a means of moving the plate and/or the coating rolls in a vertical direction; and a means of supplying the coating solution to at least one coating roll, for forming a film of the coating solution on at least one surface of the plate by passing the plate between the coating rolls.

### BRIEF DESCRIPTION OF THE DRAWINGS

FIGS. 1(A) and 1(B) are schematic diagrams showing a state wherein a plate is being coated according to the present invention. FIG. 1(A) is a perspective view thereof, while 1(B) is a cross-sectional side view taken along the line B-B of FIG. 1(A).

FIGS. 2(A) and 2(B) are schematic diagrams showing an example of means of holding and moving a plate according to the invention. FIG. 2(A) is a front view thereof, while 2(B) is a side view thereof.

FIGS. 3(A) and 3(B) are schematic diagrams showing means of fixing a plate. FIG. 3(A) is a front view thereof, while 3(B) is a side view thereof.

FIGS. 4(A) and 4(B) are schematic diagrams showing another means of fixing a plate. FIG. 4(A) is a front view thereof, while 4(B) is a side view thereof.

FIGS. 5(A) and 5(B) are schematic diagrams showing a constitution of coating rolls and backup rolls. FIG. 5(A) is a perspective view thereof, while 5(B) is a cross-sectional side view taken along the line Y-Y of FIG. 5(A).

FIG. 6 is a side view schematically showing an arrangement for supplying a coating solution to two coating rolls from coating solution tanks placed under coating rolls.

FIG. 7 is a side view schematically showing an arrangement of a means of supplying a coating solution over contacting portions of coating rolls and backup rolls.

FIG. 8 is a perspective view schematically showing an arrangement for supplying a coating solution over contacting portions of coating rolls and backup rolls utilizing a means of supplying the coating solution.

FIG. 9 is a perspective view schematically showing another arrangement for supplying a coating solution over contacting portions of coating rolls and backup rolls utilizing a means of supplying the coating solution.

FIG. 10 is a perspective view schematically showing an arrangement for supplying a coating solution from a coating solution tank to a backup roll and transferring the coating solution from the backup roll to a coating roll.

FIG. 11 is a flowchart showing an arrangement for circulating a coating solution.

FIG. 12 is a graph showing a distribution of a thickness of a coated film along vertical direction on a surface of a plate resulting from the Example 1 of the present invention.

FIG. 13 is a graph showing a distribution of a thickness of a coated film along horizontal direction on a surface of a plate resulting from the Example 1 of the present invention.

FIG. 14 is a graph showing a distribution of a thickness of a coated film along vertical direction on a surface of a plate resulting from the Example 2 of the present invention.

FIG. 15 is a graph showing a distribution of a thickness of a coated film along vertical direction on a surface of a plate resulting from the Example 3 of the present invention.

FIG. 16 is a graph showing a distribution of a thickness of a coated film along horizontal direction on a surface of a plate resulting from the Example 3 of the present invention.

FIG. 17 is a graph showing a distribution of a thickness of a coated film along vertical direction on a surface of a plate resulting from the Example 4 of the present invention.

### DETAILED DESCRIPTION OF THE PREFERRED EMBODIMENTS

The present invention is explained, mainly about a method for forming coated films on both surfaces of the plate, in further details referring to the attached drawings as below:

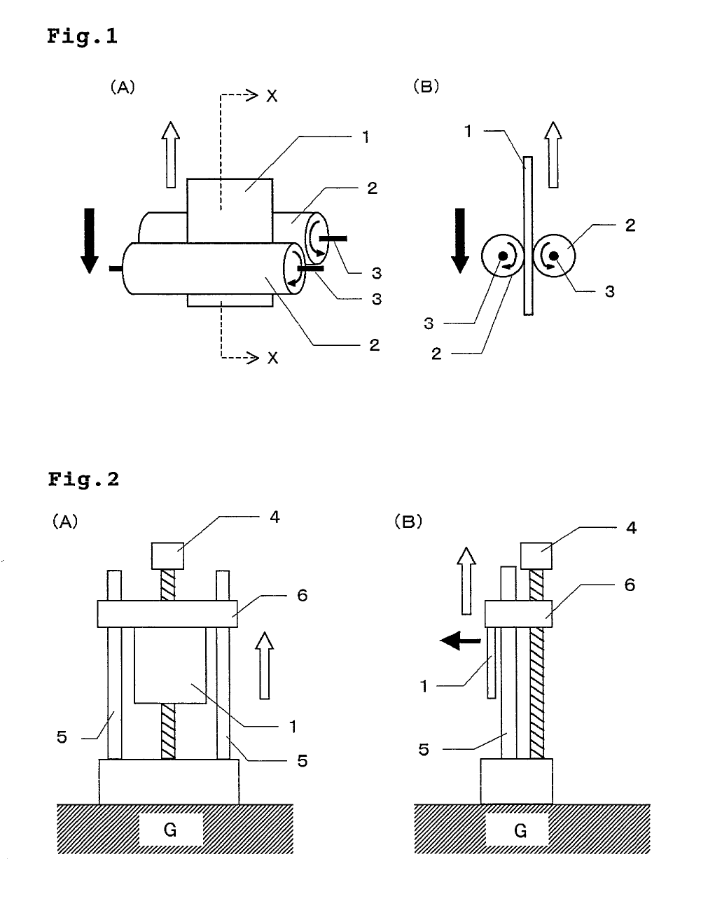

According to the present invention, a plate 1 is held in such a way that the surfaces thereof to be coated become substantially parallel to a gravity direction, the plate 1 is placed between two coating rolls 2,2 having substantially horizontal rotation axes 3,3, the plate 1 is made to pass between coating rolls 2, 2 wherein the plate 1 almost contacts with the coating rolls 2, 2, and the coating solution supplied in advance to the surface of coating rolls 2, 2 is coated on the surfaces of the plate 1, as shown in FIG. 1. For coating purpose, the plate 1 is moved relatively upward against coating rolls 2, 2. More specifically, either the plate 1 can be moved upward as shown by white arrows in FIG. 1, or coating rolls 2, 2 can be moved downward as shown by black arrows. Further, it is also possible to move the plate 1 upward while moving coating rolls 2,2 downward. Accordingly, it is an important feature of the present invention that the plate 1 is placed vertically and coating is performed while the plate 1 is moved in a vertical direction parallel to the surfaces to be coated.

The plate 1 is preferable in a cut sheet form, and nature thereof is not specifically limited, while for instance sheet glass or molded resin products are typically employed. Molded resin products include, (meth)acrylic resin, polycarbonate resin, cellulose resin, polystyrene resin, styrene-(meth)acrylic copolymer resin, etc. (Meth)acrylic represents acrylic and/or methacrylic.

A dimension of the plate 1 is not specifically limited, while preferable dimensional range thereof is about 300 mm to about 2,000 mm in width, about 500 mm to about 4,000 mm in length and about 0.1 mm to about 20 mm in thickness. Referring to the above-described dimension, longer side of rectangle is defined as length and shorter side as width. Among the four sides of the plate 1, at least one side is fixed and held. FIG. 2 shows a state wherein the upper side (of widthwise direction) of the plate 1 is fixed by fixing frame 6, while it is also possible to fix a side of length. The plate 1 is placed so that normal line of surface to be coated shown by the black arrow in FIG. 2(B) is placed parallel to the ground G.

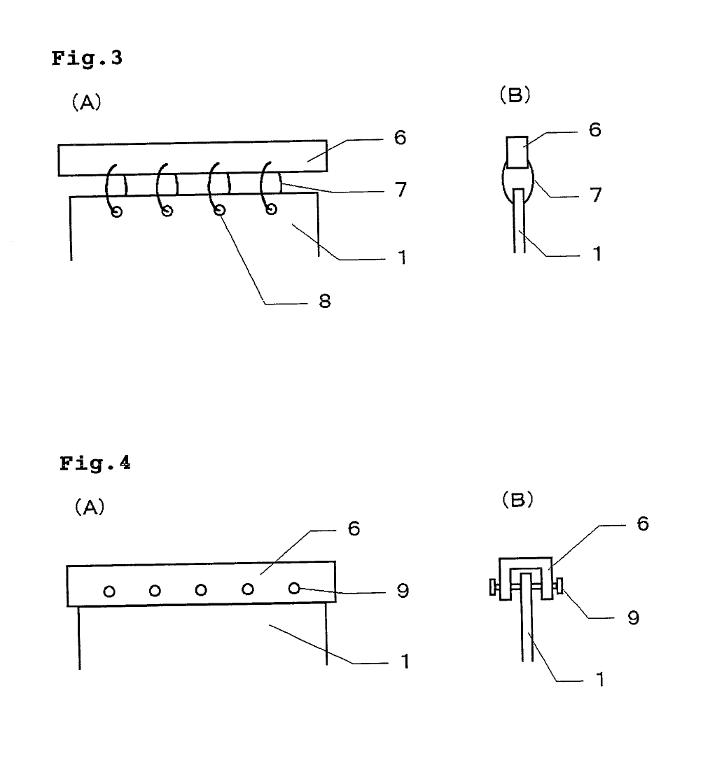

A method for fixing a plate 1 is not specifically limited, while it is preferable to make a plurality of holes 8, 8 near a side edge to be fixed and to pass hang-up device 7, 7 made of string or wire through holes 8, 8, thus to suspend the plate 1 as shown in FIG. 3, or to use a means of holding 9, 9 such as vise or fixing screws to fix a plate 1 with fixing frame 6 as FIG. 4. In addition, a clamping device can also be employed. Upper side of the plate 1 held by a means of holding as shown in FIGS. 2 to 4 is usually positioned above an area to be disposed between two coating rolls 2, 2, so that a coating solution will be supplied to the area lower than where coating rolls 2, 2 are positioned at first, however such a means of holding is omitted in other drawings. Also, the upper side of a plate 1 where the coating solution is not supplied and a coated film is therefore not formed is usually cut off after completion of coating process.

The plate 1 fixed or the coating rolls 2, 2 are moved vertically at a constant speed. When moving the plate 1, it is moved upward in a direction vertical to the ground G as shown by white arrows in FIGS. 1 and 2. For moving the plate 1 it is preferable to connect a fixing frame 6 with a ball screw a that is connected with a motor, as shown in FIG. 2. In this case the fixing frame 6 engaged by thread with the ball screw 4 moves up and down according to rotation of the ball screw 4, and the plate 1 fixed with the fixing frame 6 also moves up and down along with the fixing frame 6. It is also preferable to install guide rails 5, 5 for guiding upward and downward movement of the fixing frame 6, to smoothen and stabilize the mentioned movement. Meanwhile when moving the coating rolls 2, 2 they are moved downward in a direction vertical to the ground G, as shown by black arrows in FIGS. 1 and 2. Moving speed of the plate 1 or the coating rolls 2, 2 is not specifically limited, while a speed range of about 0.5 meters to about 20 meters per minute is preferable. If moving speed is too slow production efficiency is lowered, on the other hand too fast moving speed may result in irregular coating surface.

Coated films are formed on the surfaces of the plate 1 when the plate 1 passes between two parallel coating rolls 2, 2 to which a coating solution is adhered, as shown in FIG. 1. A size of the coating rolls 2, 2 is to be determined according to dimension of the plate 1, and usually it is preferable to employ such rolls that are about 10 mm to about 1,000 mm longer than horizontal length of the plate 1. A diameter of the coating rolls 10,10 is not specifically limited either, while a range of about 50 mm to about 500 mm is preferable.

Materials of the coating rolls 2, 2 are not specifically limited, while generally such materials that are resistant to the coating solution are selected. It is preferable that the surface of the coating rolls 2, 2 comprises an elastic material such as rubber or resin, for following a possible deformation of the plate 1 such as camber or flexure. A rubber or resin for the surface of the coating rolls 2, 2 is selected from among those materials resistant to the coating solution. For instance, in case a coating solution to be supplied contains an organic solvent, either of butyl rubber, ethylene-propylene rubber, nitrile rubber, styrene-butadiene rubber, silicon rubber, urethane resin, fluorine containing resin, etc. may be selected depending on nature of the solvent to be used. A layer thickness of elastic material to be provided on the surface of the coating rolls is not specifically limited, while an elastic layer of about 3 mm to about 50 mm of thickness is typically employed. Also, it is preferable that such elastic material has a hardness of about 20 to about 80 under Schedule A of Spring Hardness Test according to JIS K6301.

For coating both surfaces of the plate 1, two coating rolls 2, 2 are placed with such amount of clearance between each other that allows the plate 1 to pass through, as shown in FIG. 1. A clearance between the coating rolls 2, 2 varies depending on nature of material thereof, while it is preferable to make a clearance that is the same as or greater than the thickness of the plate 1, in case the roll surface is made of such an elastic material as those mentioned above. Specifically it is preferable to set a clearance of about 100% to about 150% of the thickness of the plate 1, and about 0 mm to about 0.5 mm greater than the thickness of the plate 1. When using the coating rolls 2, 2 with elastic surface it is possible to set a clearance smaller than the thickness of the plate 1 in unloaded state and execute a coating process, however in such a case friction between the plate 1 and the coating rolls 2, 2 may become so great as to cause vibration.

When starting up a coating process, it is preferable that firstly the clearance between the coating rolls 2, 2 is widened, and either the plate 1 is lowered into between the coating rolls 2, 2 or the coating rolls 2, 2 are lifted maintaining the widened clearance, until the lower edge of the fixing frame 6 is substantially aligned with the upper edge of the coating rolls 2, 2, when movement of the plate 1 or the coating rolls 2, 2 is stopped, or moving direction is reversed. Then the clearance between the coating rolls 2, 2 is narrowed to reach a clearance predetermined according to the aforementioned way, and either the plate 1 is lifted at a predetermined speed or the coating rolls 2, 2 are lowered at a predetermined speed so that the coating solution is supplied to both surfaces of the plate 1. Otherwise it is also possible to push the plate 1 upward from the bottom thereof and to hold the upper end of the plate 1 once the upper end passes between the coating rolls 2, 2, and to keep lifting the plate 1 upward at a predetermined speed. In order to adjust the clearance between the coating rolls 2, 2 it is preferable to provide a means of movement in a horizontal direction perpendicular to rotation axes 3, 3, to at least one of the coating rolls 2, 2. Also, in case the coating rolls 2, 2 are to be lowered during a coating process, a means of movement in a vertical direction can be provided. It is preferable to drive such movement of the coating rolls 2, 2 in horizontal or vertical direction utilizing a motor, or a pneumatic or hydraulic pressure system.

When narrowing the clearance of the coating rolls 2, 2 to set to a predetermined value, the clearance can be adjusted either while the relative upward or downward movement of the plate 1 against the coating rolls 2, 2 is stopped, or while moving the plate 1 relatively upward against the coating rolls 2, 2, instead of stopping the movement. When adjusting the clearance between the coating rolls 2, 2 while the relative ascent of the plate 1 is stopped, the relative ascent can be started again immediately upon setting a predetermined clearance, or after a certain time, for example several seconds. When adjusting the clearance between the coating rolls 2, 2 while the plate 1 is relatively ascending against the coating rolls 2, 2, it is preferable to move rotating the coating rolls 2, 2 toward the plate 1. On the other hand, when adjusting the clearance between the coating rolls 2, 2 while the movement of the plate 1 is stopped, the coating rolls 2, 2 can start rotating either before or after setting a predetermined clearance. From the viewpoint of control of the coating rolls 2, 2 it is preferable to start the rotation prior to setting a predetermined clearance, while if the rotation is to be started after setting the clearance it is preferable to start the ascent of the plate 1 or descent of the coating rolls 2, 2 with a certain time lag after setting the roll clearance, so that the coating solution can spread over the coating rolls 2, 2 more evenly and entirely.

Two coating rolls 2, 2 are respectively provided with means of driving such as a motor. It is preferable that the coating rolls 2, 2 are made to rotate in a direction opposite to movement of the plate 1. Specifically, whereas the plate 1 moves relatively upward against the coating rolls 2, 2, the coating rolls 2, 2 rotate downward to supply the coating solution to both surfaces of the plate 1 at a position where the coating rolls 2, 2 are confronting the plate 1. Making the coating rolls 2, 2 rotate in a direction opposite to the relative movement of the plate 1 will result in increased transferability of the coating solution. Since the coating rolls 2, 2 rotate in a direction opposite to the movement of the plate 1, rotating direction of each of the coating rolls 2, 2 becomes opposite to each other. Rotating speed of the coating rolls 2, 2 is not specifically limited but is determined according to a roll diameter or a moving speed of the plate 1, while usually a range of about 0.05 to about 50 rpm is preferable. Converting to a rotational circumferential speed, a range of about 0.1 to about 3 meters per minute is preferable.

The surfaces of the coating rolls 2, 2 can either be flat or uneven. Also, it is preferable to form fine grooves on the surfaces of the coating rolls 2, 2 for adjusting a coating thickness to a desired level. Examples of cross-sectional shape of grooves to be formed on the surfaces of the coating rolls 2, 2 include V-shape, semicircle, or trapezoid etc., but not limited to the mentioned ones. Such fine grooves can be formed on the surfaces of the coating rolls 2, 2 in plural concentric circles or in singular or plural spirals, or further, along a longitudinal direction of the rolls. A depth of grooves to be formed on the surfaces of the coating rolls 2, 2 is not specifically limited, while a range of about 0.01 to about 1 mm is preferable. Also, a distance between center of a groove and that of an adjacent one (pitch of grooves) is not specifically limited, while a range of about 0.01 to about 5 mm is preferable.

A diameter of the coating rolls 2, 2 is typically constant from one end to the other thereof, while it is advantageous to crown coating rolls 2, 2 lengthwise making a diameter of central portion slightly greater than that of end portions, for applying constant contacting pressure to the plate 1. In such a case, it is preferable that the diameter of the thinnest portion of the rolls exceeds about 90%, ideally about 99%, of the diameter of the thickest portion thereof.

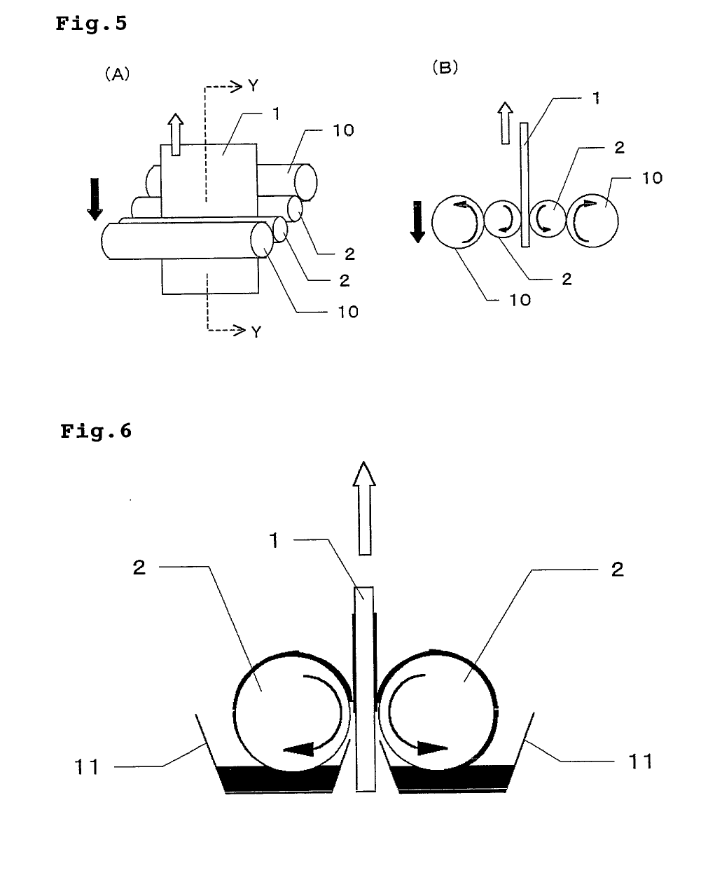

As shown in FIG. 5, it is preferable to provide backup rolls (subsidiary rolls) 10, 10 so as to contact with the coating rolls 2, 2 on the respective opposite sides of the plate 1 across the coating rolls 2, 2. In this case it is preferable to dispose the backup roll 10 in parallel with the coating roll 2 and in close contact with each other. The backup roll 10 synchronizes with the coating roll 2, rotating in the opposite direction to the coating roll 2. A rotating speed of the coating roll 2 and that of the backup roll 10 are in accordance in terms of surface speed, and means of driving such as a motor can be provided either to one of these rolls so that the other will also be driven together, or to both of the rolls.

Materials of the backup rolls 10, 10 are not specifically limited, while generally such materials that are resistant to the coating solution are selected. Normally a metallic roll made of a stainless steel is preferably employed, because of ease of surface machining and rigidity, etc. Surfaces of the backup rolls 10, 10 can either be flat or uneven. Also, it is preferable to form fine grooves or minute holes on the surfaces of the backup rolls 10, 10 for supplying a desired amount of the coating solution to the coating rolls 2, 2, as will be described later. Examples of cross-sectional shape of grooves to be formed on the surfaces of the backup rolls 10, 10 include V-shape, semicircle, or trapezoid etc., but not limited to the mentioned ones. Such fine grooves can be formed on the surfaces of the backup rolls 10, 10 in plural concentric circles or in singular or plural spirals, or further, along a longitudinal direction of the rolls. Further, when forming minute holes on the surfaces of the backup rolls 10, 10, shape of the holes is selected from among round or polygonal shapes such as a triangle or square, etc. Also, a depth of grooves or holes to be formed on the surfaces of the backup rolls 10, 10 is not specifically limited, while a range of about 0.001 to about 1 mm is preferable. A diameter of the backup rolls 10, 10 is not specifically limited either, while usually a range of about 50 to about 500 mm is preferable.

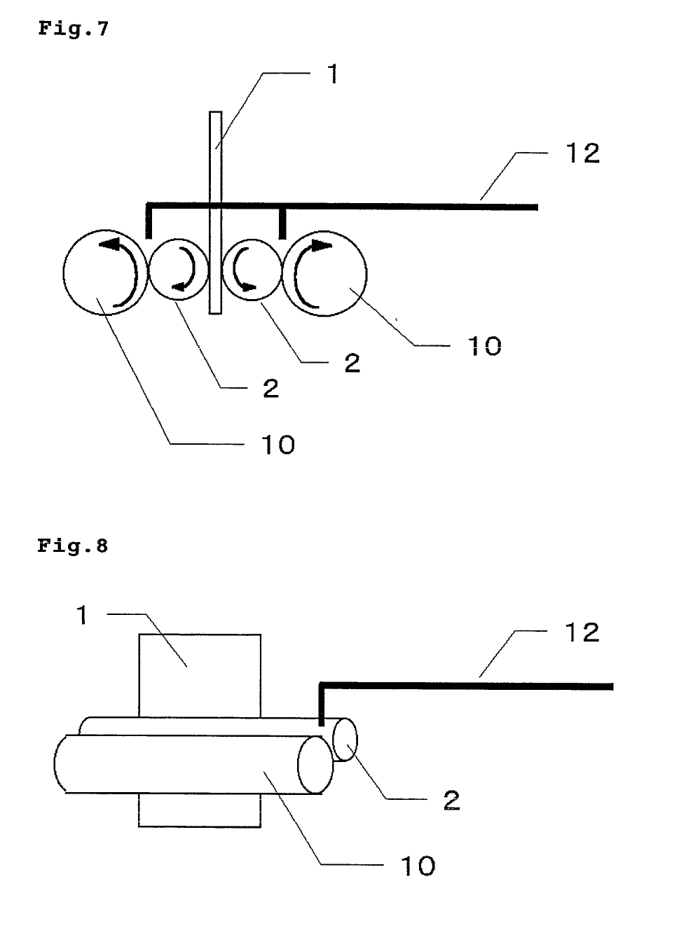

To the coating rolls 2,2 the coating solution is to be supplied. Normally it is desirable that the coating solution is supplied all over the coating rolls 2, 2 before the coating rolls 2, 2 contacts with the plate 1. When supplying the coating solution to the coating rolls 2, 2 it is desirable that the coating solution fully covers an area that contacts with the plate 1, and for such purpose it is preferable to provide tanks 11, 11 under the coating rolls 2, 2 as shown in FIG. 6, for dipping the coating rolls 2, 2 in the coating solution in tanks 11, 11 so that the coating solution is supplied to the coating rolls 2, 2.

Also, when employing the backup rolls 10, 10, it is preferable to provide a means of supplying the coating solution 12, over a contacting portion of the coating roll 2 and the backup roll 10 as shown in FIG. 7, so that the coating solution flows down from means of supplying the coating solution 12. In such a case means of supplying the coating solution 12 can be placed in the proximity of an end portion of contacting area of the coating roll 2 and backup roll 10 as shown in FIG. 8, while it is also preferable to provide means of supplying the coating solution 12 comprising a plurality of flow nozzles disposed from an end portion of contacting area of the coating roll 2 and the backup roll 10 toward the other end portion thereof, so that the coating solution is supplied from such plurality of flow nozzles substantially evenly along a longitudinal direction of the rolls. Quantity of the coating solution to be supplied is not specifically limited as far as the coating solution adheres all over the coating roll 2, while normally a preferable range is about 1 to about 5 liters per minute per a roll. Such quantity varies depending on a diameter or a length of the coating roll 2 and the backup roll 10. Normally such an amount that forms a puddle of the coating solution all over the contacting portion of the coating roll 2 and the backup roll 10 is considered to be sufficient.

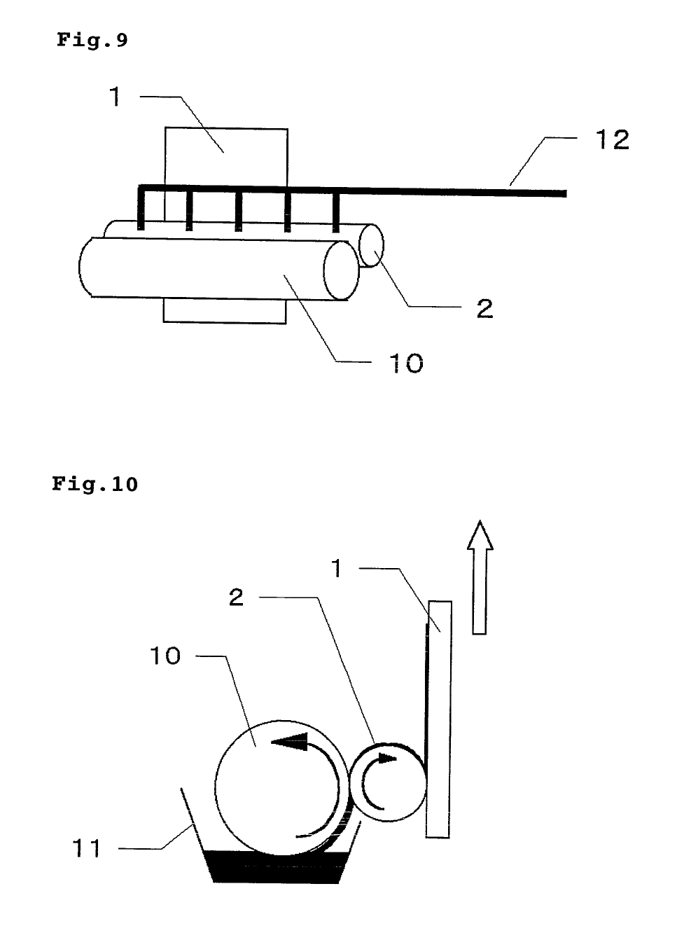

FIG. 10 shows another arrangement for supplying the coating solution. According to this arrangement, the tank 11 is provided under the backup roll 10, and lower end portion of the backup roll 10 is dipped in the coating solution in the tank 11 so that the coating solution is supplied to the backup roll 10, after which the coating solution is transferred to the coating roll 2 at the contacting portion of the coating roll 2 and the backup roll 10. A method shown by FIG. 10 is especially effective when the backup roll 10 is provided with fine grooves or minute holes on the surface thereof. Also, as is proven by this example, means of supplying the coating solution to the coating rolls implicates not only arrangements for supplying the coating solution directly to the coating rolls, but also arrangements for supplying indirectly. Further, FIGS. 8 to 10 only show a pair of the coating roll 2 and the backup roll 10 on one side, however it is to be explicitly understood that another symmetrical pair of the coating roll 2 and the backup roll 10 is provided on the other side of the plate 1.

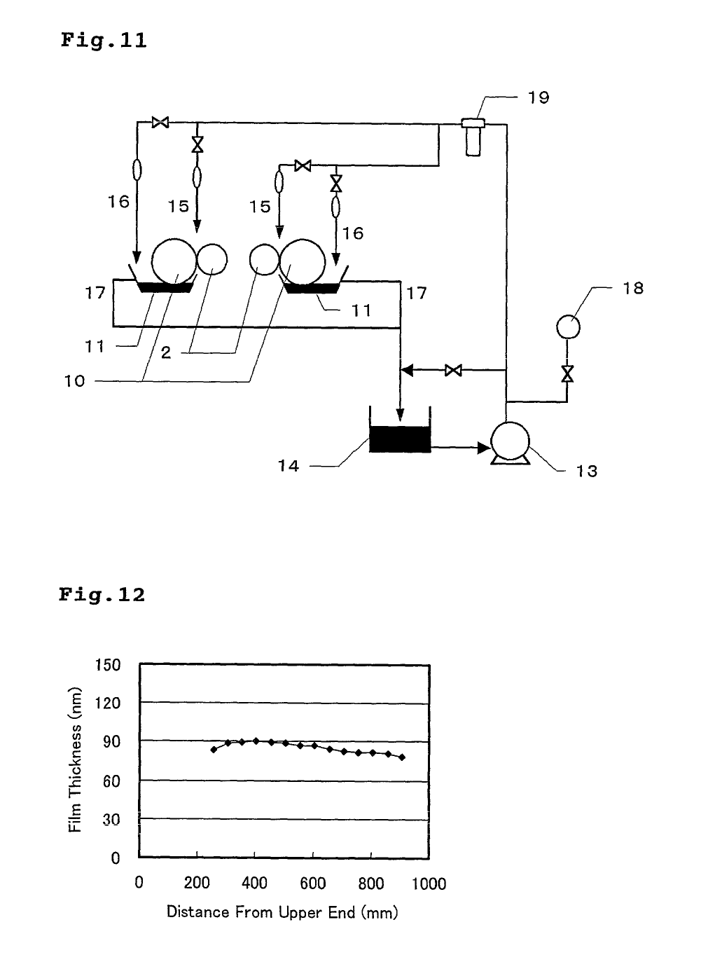

According to the present invention it is preferable to provide means of circulation such as a pump for circulating the coating solution. Specifically, it is preferable to place a tank for storing the coating solution therein, and to circulate the coating solution from the tank to the coating rolls via means of supplying the coating solution, and back to the tank again. FIG. 11 is a flowchart showing an example of arrangement for circulating the coating solution. According to this example, the coating solution is aspirated by a pump 13 from a main tank 14 in which the coating solution is stored, and the flow is branched so that the coating solution will be supplied to contacting portion of the coating rolls 2, 2 and the backup rolls 10, 10 through supply routes 15, 15 of the coating solution for the rolls as well as to the tanks 11, 11 through supply routes 16, 16 of the coating solution for the tanks.

In case the coating solution is to be supplied between the coating roll 2 and the backup roll 10 through flow nozzles as shown in FIGS. 7 to 9, it is preferable to provide the flow nozzles at the end of supply routes 15, 15 of the coating solution for the rolls so that the coating solution flows down out of such flow nozzles. With such an arrangement too, it is preferable to place the tank 11 under the coating roll 2 and the backup roll 10 at a position where the tank does not contact with the backup roll 10, so that surplus coating solution flows down into the tank 11 from the puddle between the coating roll 2 and the backup roll 10. Meanwhile, in case of employing an arrangement to apply the coating solution to the backup roll 10 by dipping lower end portion of the backup roll 10 in the coating solution in the tank 11 as shown in FIG. 10, it is preferable to place the tank 11 close below the backup roll 10 as shown in FIG. 11 and to supply the coating solution to the tanks 11, 11 through supply routes of the coating solution for the tanks 16, 16. In such a case, it is not necessary to supply the coating solution through supply routes 15, 15 of the coating solution for the rolls.

Further, in any of the foregoing cases, surplus coating solution in the tank 11 is collected back to the main tank 14 by overflow through collection routes 17, 17. According to FIG. 11, it is desirable to provide a pressure gauge 18 for detecting through a valve the pressure of the coating solution aspirated by the pump 13, since the pressure gauge 18 can also detect abnormality such as clogging of pipe. It is also desirable to remove dust that may be contained in the coating solution, by purifying the coating solution through a filter 19 either immediately after pumping up or before supplying to between the rolls 2, 10 or the tank 11.

For circulating the coating solution, it is also possible to directly aspirate the coating solution by the pump 13 on its way back from the tanks 11, 11 through collection routes 17, 17, skipping the main tank 14 shown in the flowchart of FIG. 11. Also, specific methods to be employed in supply routes of the coating solution 15 and 16 can be optionally selected according to constitution of equipments. Further, though the foregoing description refers to FIG. 11 that shows a coating solution circulation system appropriate for means of supplying the coating solution shown in FIGS. 7 to 10, a similar arrangement of the coating solution circulation can be made based on the example of FIG. 11 even when other means of supplying the coating solution is employed. For example, in case the coating solution is supplied by dipping the coating rolls 2, 2 directly in the coating solution as shown in FIG. 6, the coating solution can be circulated in a similar way to FIG. 11, except that the backup rolls 10, 10 are omitted and the tanks 11, 11 are disposed under the coating rolls 2, 2 so that lower end portion of the coating rolls 2, 2 are dipped in the coating solution in the tanks 11, 11.

By the foregoing method and arrangement, films of the coating solution are formed on the plate 1. The plate 1 is then dried to remove solvent contained in the coating solution, and a finished product is obtained. If necessary, after solvent is removed the plate 1 may further be heated or irradiated by activated radial rays such as ultraviolet rays or electronic beams, to cure the coated film by cross-linking or polymerization.

Method and apparatus according to the present invention is suitable for forming coated films on both surfaces of the plate, while it is also possible to form a coated film on only one side of a plate if so desired. For instance, one side application can be performed with supplying the coating solution to only one of the coating rolls. Also, the following steps can be taken: placing a sheet of a plate over another and fixing end portion thereof using a double-sided adhesive tape to tightly adhere both plates so that a coating solution does not enter between the plates; passing the combined plates between two coating rolls placed vertically according to the invention to apply a coating solution to the plates; and separating the two plates after coating, or after necessary post treatment. The above-described method offers better productivity than prior arts since two plates can be coated at a time.

### EXAMPLES

Hereunder, further details of the present invention are explained according to the following examples, however it is to be understood that the invention is not limited to the following examples.

Percentage expressions in the examples are by weight unless otherwise noted.

All hardness values are based on Schedule A of Spring Hardness Test according to JIS K6301.

### Example 1

As a coating solution, an anti reflection coating solution “Opstar JM5022” (manufactured by JSR; containing 3% of fluorine contained resin) diluted to 2% of concentration by methyl isobutyl ketone was used. A scratch-resistant polymethylmethacrylate resin plate (“Sumipex E MR-2000”, a hard coated plate manufactured by Sumitomo Chemical Co., Ltd.) of 930 mm in width, 1,100 mm in length and 2.5 mm in thickness was used as a plate, and was fixed with a carrying device with its lengthwise side up as shown in FIG. 2.

Coating rolls 2, 2 and backup rolls 10, 10 were disposed as shown in FIG. 5, and the coating solution was supplied through means of supplying the coating solution 12 (flow nozzle) as shown in FIG. 8 to the respective contacting portions of the coating rolls and the backup rolls. The coating solution was circulated according to the flowchart of FIG. 11. However the backup rolls 10, 10 were not dipped in the coating solution in tanks 11, 11, therefore the tanks 11, 11 were placed at a lower position than in the drawing.

Two rolls of 1,500 mm in length and 100 mm in diameter comprising a 10 mm thick surface layer consisting of ethylene-propylene rubber with a hardness of 20 were used as coating rolls 2, 2. These rolls had been polished to smoothen the surfaces. As the backup rolls 10, 10, two rolls of 1,500 mm in length and 150 mm in diameter made of stainless steel with smooth surface were used. Supply rate of the coating solution to contacting portion of the coating roll 2 and the backup roll 10 was 0.8 liters per minute on each side. This quantity was such that a puddle of the coating solution was formed at the contacting portion of the coating roll 2 and the backup roll 10, and surplus coating solution was dripping from both ends of the rolls. The coating solution that dripped out was entrapped in the tank 11 disposed under the backup roll 10. Thus a certain amount of the coating solution accumulated in each of the tanks 11, 11, besides the coating solution was constantly supplemented through supply routes 16, 16 of the coating solution of FIG. 11. The coating solution that accumulated in the tanks 11, 11 was collected back to the main tank 14 by overflow through collection routes 17, 17.

The coating rolls 2, 2 were not provided with means of driving but two backup rolls 10, 10 were respectively provided with independent means of driving. The coating roll 2 was pressed onto the backup roll 10 and adjustment was made so that the coating roll 2 could rotate at a predetermined speed. A clearance between two coating rolls 2, 2 was adjusted to be 2.8 mm during application, and the coating rolls 2, 2 were made to rotate downward at the point where the rolls confronted the plate 1, at a rotational circumferential speed of 0.6 meters per minute respectively.

The plate 1 was first lowered at a speed of 3 meters per minute into between two coating rolls 2, 2 while the clearance between the coating rolls 2, 2 was 50 mm, and stopped once when the lower edge of the fixing frame 6 came down to 50 mm above the upper edge of the coating rolls. Then the plate 1 was lifted at a speed of 3 meters per minute, while at the same time the clearance between two coating rolls 2, 2 was narrowed to 2.8 mm. Under such a situation, coated film was formed on the surface of the plate 1 by lifting up the plate 1 at a speed of 3 meters per minute while rotating the coating rolls 2, 2 downward at the mentioned circumferential speed. The plate that has been coated was dried for 10 minutes at 40° C. and irradiated by ultraviolet rays at a rate of 500 mJ/cm², for curing the coated film.

Thickness of the cured film was calculated based on measurement of absolute mirror reflection spectrum of incident angle of 5 degrees by a spectrophotometer “UV-3100PC” (manufactured by Shimadzu Corporation), after applying black paint to the back side of the coated plate. A film thickness d(nm) was calculated from the wavelength(λmin) at which reflectance becomes the minimum, according to the following formula:

d=λmin/4n

wherein n represents refractive index of cured film(1.437).

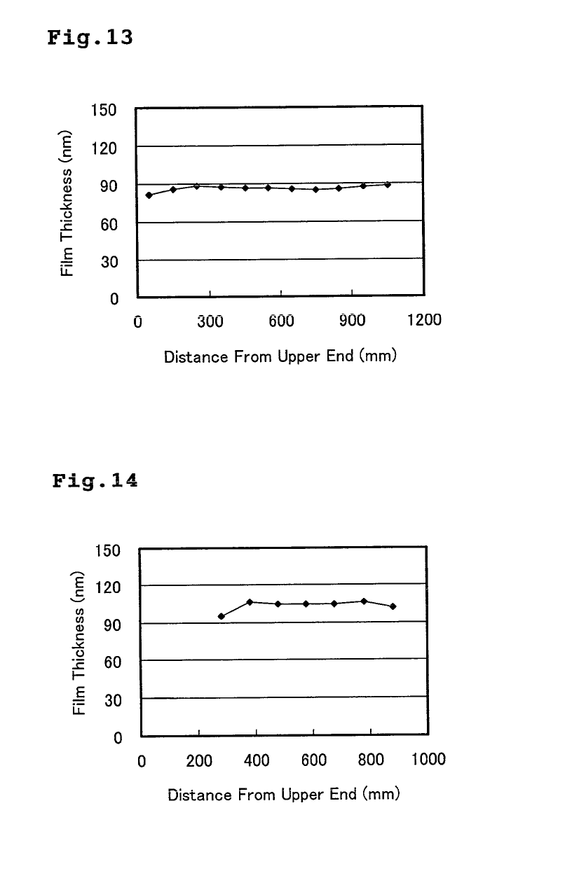

A coating thickness was measured at an interval of 50 mm to a widthwise direction of the plate (vertical direction while being carried), and the results are shown in FIG. 12. Also, a coating thickness along longitudinal direction (horizontal direction while being carried) was measured at an interval of 100 mm, and the results are shown in FIG. 13. These results are showing that coated film of a substantially even thickness has been formed along both vertical and horizontal directions.

### Example 2

A similar coating and curing process to that in Example 1 was performed, except that the rotational circumferential speed of the coating rolls 2, 2 was respectively set at 0.7 meters per minute. A thickness of the coated film was measured at an interval of 100 mm to a widthwise direction of the plate (vertical direction while being carried), and the results are shown in FIG. 14. Through a comparison of the Example 1 (FIG. 12) and Example 2 (FIG. 14), it is to be understood that a film thickness can be controlled with changing a rotating speed of the coating roll 2.

### Example 3

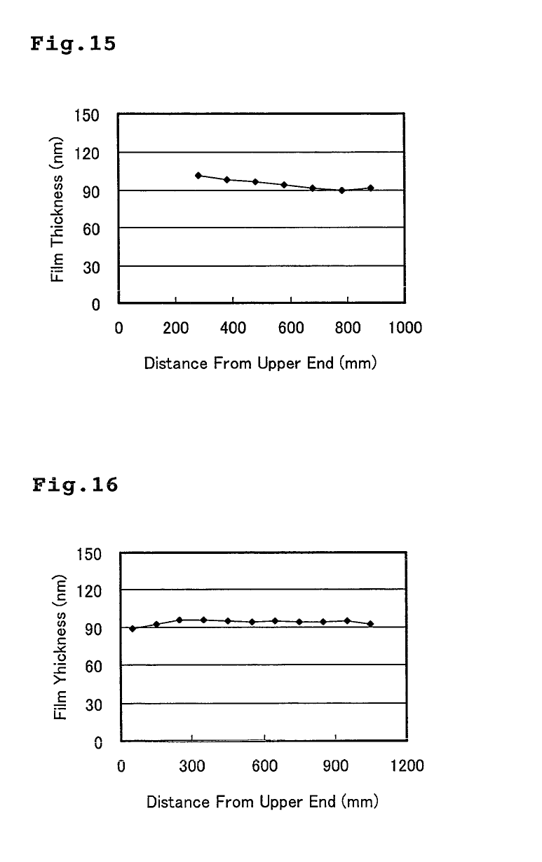

A similar coating and curing process to that in Example 1 was performed, except that the rotational circumferential speed of the coating rolls 2, 2 was respectively set at 0.9 meters per minute and moving speed of the plate 1 was set at 5 meters per minute. A thickness of the coated film was measured at an interval of 100 mm to a widthwise direction of the plate (vertical direction while being carried), and the results are shown in FIG. 15. Also, a coating thickness along longitudinal direction (horizontal direction while being carried) was measured at an interval of 100 mm, and the results are shown in FIG. 16. In this example too, a coated film of a substantially even thickness has been formed.

### Example 4

As a coating solution, an antireflection coating solution “Opstar JM5022” (manufactured by JSR; containing 3% of fluorine contained resin) diluted to 1.3% of concentration by methyl lisobutyl ketone was used. A scratch-resistant polymethylmethacrylate resin plate, which is the same as in Example 1, was used as a plate, which was fixed with a carrying device in the same manner as in Example 1.

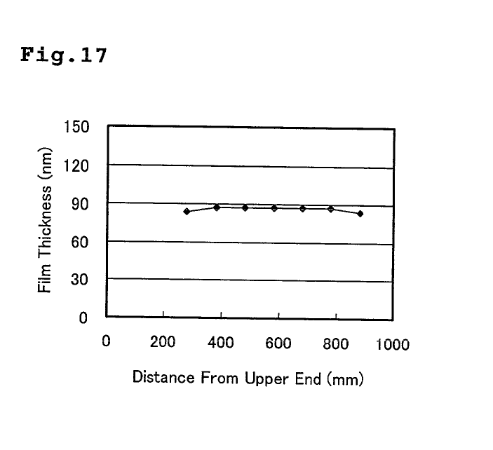

The same coating rolls 2, 2 as those in Example 1 were used, while two rolls of 1,500 mm length and 150 mm in diameter made of stainless steel, respectively comprising on the surface thereof fine v-shaped grooves of 0.2 mm in depth and 90 of groove angle formed along a circumferential direction in a pitch of 0.5 mm were used as the backup rolls 10, 10, and all these rolls were disposed as shown in FIG. 5. For supplying the coating solution, instead of supplying to contacting portion of the coating roll 2 and the backup roll 10, a certain amount of the coating solution was pooled in the tanks 11, 11 placed under the backup rolls 10, 10, in which the lower end portion of the backup rolls 10, 10 was dipped according to FIG. 10. To the tank 11, the coating solution was constantly supplemented through supply routes 16, 16 of the coating solution for the rolls of FIG. 11. Further, rotational circumferential speeds of the coating rolls 2, 2 were set at 1.2 meters per minute. Except the foregoing conditions a similar coating and post treatment to that in Example 1 was performed, thus to obtain a coated plate with a cured film. A thickness of the cured film was measured at an interval of 100 mm to a width wise direction of the plate (vertical direction while being carried), and the results are shown in FIG. 17. In this Example too, coated films of a substantially even thickness have been formed.

According to method of the present invention, simultaneous coating on both sides of a plate can be executed at a faster application speed, and coated films of a superior uniformity in thickness and of a better appearance can be obtained.

What is claimed is:

1. A method for producing a coated plate comprising the steps of:
holding a plate in such a manner that surfaces of the plate to be coated is aligned substantially parallel to a gravity direction;
placing the plate between two coating rolls having substantially horizontal rotation axes;
passing the plate between the coating rolls, wherein a coating solution is supplied to at least one coating roll and the plate almost contacts with the coating rolls, by moving the plate upward and/or moving the coating rolls downward while causing the coating rolls to rotate in a direction opposite to movement of the plate; and
forming a film of the coating solution on at least one surface of the plate.

2. The method for producing a coated plate according to claim 1, wherein the plate is in a cut sheet form.

3. The method for producing a coated plate according to claim 1, wherein a clearance between the two coating rolls is the same as or greater than thickness of the plate.

4. The method for producing a coated plate according to claim 1, wherein a clearance between the two coating rolls is about 0 mm to about 0.5 mm greater than the thickness of the plate.

5. The method for producing a coated plate according to claim 1, wherein a moving speed of the plate or the coating rolls is about 0.5 meters to about 20 meters per minute.

6. The method for producing a coated plate according to claim 1, wherein the plate is passed between the coating rolls wherein the coating solution is supplied to two coating rolls, and films of the coating solution is simultaneously formed on both surfaces of the plate.

7. An apparatus for producing a coated plate comprising:
a means of holding a plate in such a manner that surfaces of the plate to be coated is aligned substantially parallel to a gravity direction;
two coating rolls having substantially horizontal rotation axes and confronting each other with a clearance therebetween that allows the plate to pass through and almost contact with, and which rotate in a direction opposite to each other and to movement of the plate;
a means of moving the plate and/or the coating rolls in a vertical direction; and
a means of supplying the coating solution to at least one coating roll, for forming a film of the coating solution on at least one surface of the plate by passing the plate between the coating rolls.

8. The apparatus for producing a coated plate according to claim 7, further comprising two backup rolls that rotate synchronized with the coating rolls and in a direction opposite to that of the coating rolls, on the respective opposite sides of the plate across the coating rolls.

9. The apparatus for producing a coated plate according to claim 8, wherein the means of supplying the coating solution is disposed so as to supply the coating solution to contacting portion of the coating rolls and the backup rolls.

10. The apparatus for producing a coated plate according to claim 8, wherein the means of supplying the coating solution is disposed so as to supply the coating solution to the backup rolls, so that the coating solution supplied to the backup rolls is then transferred to the coating rolls.

11. The apparatus for producing a coated plate according to any of claims 7 to 10, further comprising a tank for storing the coating solution, and a means of circulating the coating solution from the tank, through the means of supplying the coating solution and via the coating rolls, and then back to the tank.
